(19) United States
(12) Patent Application Publication
(10) Pub. No.: US 2026/0131927 A1
(43) Pub. Date: May 14, 2026

(54) APPARATUS AND METHOD FOR MANUFACTURING AND INSPECTING A POUCHED PRODUCT OR AT LEAST ONE OBJECT ASSOCIATED THEREWITH

(71) Applicant: NICOVENTURES TRADING LIMITED, London (GB)

(72) Inventors: Jerry Wayne Pipes, Clemmons, NC (US); Balager Ademe, Winston-Salem, NC (US); Matthew Dean Griffitts, Thomasville, NC (US)

(21) Appl. No.: 19/120,117

(22) PCT Filed: Oct. 12, 2023
(86) PCT No.: PCT/IB2023/060317

§ 371 Date: Apr. 10, 2025

Related U.S. Application Data
(60) Provisional application No. 63/416,312, filed on Oct. 14, 2022.

(51) Int. Cl. B65B 57/04; A24B 13/00; A24B 15/16; A24B 15/28; B65B 9/20; B65B 29/00; G01N 21/90

(52) U.S. Cl. CPC B65B 57/04; A24B 13/00; A24B 15/16; A24B 15/283; B65B 9/20; B65B 29/00; G01N 21/90; B65B 2220/14

(57) ABSTRACT

An apparatus (1) and method for manufacturing a pouched product involves a forming unit forming a continuous supply of a pouch material (20) into a continuous channel member. A dosage unit (500) operably engaged with the forming unit (50) that receives at least one object (134) and introduces the object(s) into a dose of a filler material (130). The dosage unit (500) directs the dose of the filler material, having the object(s) therein, into the channel member. An inspection unit is arranged prior to the dosage unit (500), in operable engagement with the dosage unit, or prior to the forming unit, to inspect the object(s) or the object(s) within the dose of the filler material, wherein the inspection unit includes an emitter (401) arranged to oppose a detector (402) such that the object(s), or the object(s) within the dose of the filler material, is directed therebetween. An apparatus and method for inspecting a pouched product are also provided.

### FIELD OF THE DISCLOSURE

Aspects of the present disclosure are directed to an apparatus and method for manufacturing an oral pouched product and an associated apparatus and method for inspecting such a manufactured oral pouched product or at least one object included therein or associated therewith.

### BACKGROUND

There are many categories of products intended for oral use and enjoyment. For example, oral tobacco products containing nicotine, which is known to have both stimulant and anxiolytic properties, have been available for many years. Conventional formats for so-called “smokeless” tobacco products include moist snuff, snus, and chewing tobacco, which are typically formed almost entirely of particulate, granular, or shredded tobacco, and which are either portioned by the user or presented to the user in individual portions, such as in single-use pouches or sachets. See for example, the types of smokeless tobacco formulations, ingredients, and processing methodologies set forth in U.S. Pat. No. 6,668,839 to Williams; U.S. Pat. No. 6,834,654 to Williams; U.S. Pat. No. 6,953,040 to Atchley et al.; U.S. Pat. No. 7,032,601 to Atchley et al. ; and U.S. Pat. No. 7,694,686 to Atchley et al.; U.S. Pat. No. 7,810,507 to Dube et al.; U.S. Pat. No. 7,819,124 to Strickland et al.; U.S. Pat. No. 7,861,728 to Holton, Jr. et al.; U.S. Pat. No. 7,901,512 to Quinter et al.; U.S. Pat. No. 8,627,828 to Strickland et al.; U.S. Pat. No. 11,246,334 to Atchley, each of which is incorporated herein by reference.

In addition, traditional tobacco materials and non-tobacco materials have been combined with other ingredients to form product formats distinct from traditional smokeless products, with example formats including lozenges, pastilles, gels, and the like. See, for example, the types of products described in US Patent App. Pub. Nos. 2008/0196730 to Engstrom et al.; 2008/0305216 to Crawford et al.; 2009/0293889 to Kumar et al.; 2010/0291245 to Gao et al; 2011/0139164 to Mua et al.; 2012/0037175 to Cantrell et al.; 2012/0055494 to Hunt et al.; 2012/0138073 to Cantrell et al.; 2012/0138074 to Cantrell et al.; 2013/0074855 to Holton, Jr.; 2013/0074856 to Holton, Jr.; 2013/0152953 to Mua et al.; 2013/0274296 to Jackson et al.; 2015/0068545 to Moldoveanu et al.; 2015/0101627 to Marshall et al.; and 2015/0230515 to Lampe et al., each of which is incorporated herein by reference.

There is continuing interest in the development of new types of oral products that deliver advantageous sensorial or biological activity. Such products typically contain flavorants and/or active ingredients such as nicotine, caffeine, botanicals, or cannabidiol. The format of such products can vary, and include pouched products containing a powdered or granular composition, lozenges, pastilles, liquids, gels, emulsions, meltable compositions, and the like. See, for example, the types of products described in US Patent App. Pub. Nos. 2022/0160675 to Gerardi et al.; 2022/0071984 to Poole et al.; 2021/0378948 to Gerardi et al.; 2021/0330590 to Hutchens et al.; 2021/0186081 to Gerardi et al.; 2021/0177754 to Keller et al; 2021/0177043 to Gerardi et al.; 2021/0177038 to Gerardi et al.; 2021/0169867 to Holton, Jr. et al.; 2021/0169792 to Holton, Jr. et al.; 2021/0169132 to Holton, Jr. et al.; 2021/0169121 to St. Charles, and 2021/0169122 to St. Charles, each of which is incorporated herein by reference. There is continuing interest in the art to develop additional products for oral consumption, which can exhibit various release rates of active ingredients and/or enhanced shelf stability. Some users might be interested in an oral product that is capable of providing, in some instances, selectively, a variety of different flavors, depending upon the user's immediate preference. The flavor of such an oral product might be selected based on the user's preference for a particular flavor at that time, or interest in changing flavors during use. For example, changing flavors during use may enable a user to end the experience with a breath freshening flavor, such as menthol or spearmint. Accordingly, it would be appreciated to have an oral product that is capable of providing distinctive, different pleasurable sensory experiences, for a user. Some users might also be interested in an oral product that is capable of modifying the nature or character of the sensory experience generated by that oral product.

In this regard, oral products, and in particular oral pouched products, can incorporate objects, beads, capsules and capsule components such as those set forth in U.S. Patent Pub. Nos. 2006/0272663 to Dube et al., 2006/01330961 to Luan et al., 2006/0144412 to Mishra et al.; 2007/0012327 to Karles et al.; 2007/0068540 to Thomas et al.; 2008/0029110 to Dube et al.; and 2011/0271968 to Carpenter et al.; PCT WO 2006/136197; PCT WO 2006/136199; PCT WO 2007/010407 PCT WO 2007/060543 and U.S. Pat. No. 7,115,085 to Deal; and U.S. Pat. No. 7,972,254 to Stokes et al.; as well as within filtered cigarettes that have been marketed under the tradenames “Camel Lights with Menthol Boost” and “Camel Crush” by R. J. Reynolds Tobacco Company. Exemplary pelletized carrier materials and flavor packages are of the type employed in cigarettes that have been marketed commercially in the USA. For example, flavor-carrying pellets have been incorporated into cigarette filters employed on Camel brand cigarettes under the tradenames Mandalay Lime, Mandarin Mint, Breach Breezer, Back Ally Blend, Snakeyes Scotch, Izmir Stinger, Kauai Kolada, Midnight Madness, Aegean Spice, Screwdriver Slots, Twist, Twista Lime, Dark Mint and Blackjack Gin;

Kool brand cigarettes under the tradenames Flow and Groove; and Salem brand cigarettes under the tradename Deep Freeze; all of which have been marketed by R. J. Reynolds Tobacco Company.

In some instances, a user would appreciate having the ability to enhance a sensory aspect of his/her oral product sensory experience, and the extent or magnitude of that sensory experience, such as can be accomplished by allowing the user to purposefully select an oral product having certain characteristics or behaviors and, in some instances, by allowing the user to determine the magnitude or extent of such characteristics or behaviors that the oral product exhibits. That is, it would be appreciated to have oral product possessing components that can be employed so as to allow the user to select an oral product based on an indicated character or nature and, in some instances, allow the user to control, whether selectively or not, the nature or character of the sensory characteristic produced by that oral product, and the source from which it is obtained. In particular, it would be appreciated to have an oral product that is capable of enhancing the sensory attributes, and the extent or magnitude of such attributes, of the sensory characteristic (e.g., flavoring). More particularly, it would be appreciated to have the capability of manufacturing such oral products incorporating such flavor agents and sources, and the like, in a rapid, highly-automated fashion. It also would be appreciated to have improved provisions for incorporating product-altering solid objects such as flavor pellets, flavor capsules, or possibly various combinations thereof, into oral products, in a rapid, highly automated fashion. It would additionally be appreciated that such manufacturing capabilities include the capability of inspecting and/or monitoring the manufacturing apparatus, the as-formed oral product, and/or component(s) of the oral product prior to the formation thereof.

### SUMMARY OF THE DISCLOSURE

The above and other needs are met by aspects of the present disclosure which, in one aspect, provides an apparatus for manufacturing a pouched product. Such an apparatus comprises a forming unit arranged to form a continuous supply of a pouch material into a continuous channel member defining a longitudinal axis. A dosage unit is operably engaged with the forming unit and is arranged to receive at least one object and to introduce the at least one object into a dose of a filler material. The dosage unit is further arranged to direct the dose of the filler material, having the at least one object within the dose, into the channel member. An inspection unit is arranged prior to the dosage unit, operably engaged with the dosage unit, or arranged prior to the forming unit. The inspection unit further is arranged to inspect the at least one object prior to insertion thereof into the dose of the filler material, or to inspect the dose of the filler material having the at least one object within the dose. The inspection unit includes an emitter arranged to oppose a detector such that the at least one object, or the dose of the filler material having the at least one object within the dose, is directed therebetween.

Another aspect of the present disclosure provides a method of manufacturing a pouched product.

Such a method comprises feeding a continuous supply of a pouch material using a forming unit, wherein the pouch material is configured as a continuous channel member defining a longitudinal axis. At least one object is introduced into a dose of a filler material using a dosage unit operably engaged with the forming unit, and the dose of the filler material, having the at least one object within the dose, is directed into the channel member. The at least one object, or the at least one object within the dose of the filler material, is inspected using an inspection unit arranged prior to the dosage unit, operably engaged with the dosage unit, or arranged prior to the forming unit, wherein the inspection unit includes an emitter arranged to oppose a detector such that the at least one object, or the at least one object within the dose of the filler material, is directed therebetween.

Yet another aspect of the present disclosure comprises an apparatus for inspecting a pouched product. Such an apparatus comprises a forming unit arranged to form a pouched product from a pouch material, wherein the pouched product has therein a dose of a filler material and at least one object within the dose. A conveying unit is arranged to receive the pouched products from the forming unit and is adapted to convey the pouched products to a packaging unit for packaging the pouched products. An inspection unit is operably engaged with the conveying unit and is arranged prior to the packaging unit to inspect each pouched product directed to the packaging unit. The inspection unit includes an emitter arranged to oppose a detector such that the pouched products are conveyed therebetween.

Still another aspect of the present disclosure comprises a method of inspecting a pouched product. Such a method comprises forming a pouched product from a pouch material using a forming unit, wherein the pouched product has therein a dose of a filler material and at least one object within the dose. The pouched products are received from the forming unit with a conveying unit adapted to convey the pouched products toward a packaging unit for packaging the pouched products. The pouched products are conveyed, with the conveying unit, through an inspection unit operably engaged with the conveying unit and arranged prior to the packaging unit, the inspection unit including an emitter arranged to oppose a detector such that the pouched products are conveyed therebetween, to inspect each pouched product directed toward the packaging unit.

The present disclosure thus includes, without limitation, the following example embodiments:

Example Embodiment 1: An apparatus for manufacturing a pouched product, the apparatus comprising a forming unit arranged to form a continuous supply of a pouch material into a continuous channel member defining a longitudinal axis; a dosage unit operably engaged with the forming unit and arranged to receive at least one object and to introduce the at least one object into a dose of a filler material, the dosage unit being further arranged to direct the dose of the filler material, having the at least one object within the dose, into the channel member; and an inspection unit arranged prior to the dosage unit, operably engaged with the dosage unit, or arranged prior to the forming unit, the inspection unit further being arranged to inspect the at least one object prior to insertion thereof into the dose of the filler material, or to inspect the dose of the filler material having the at least one object within the dose, the inspection unit including an emitter arranged to oppose a detector such that the at least one object, or the dose of the filler material having the at least one object within the dose, is directed therebetween.

Example Embodiment 2: The apparatus of any preceding example embodiment, or combinations thereof, wherein the emitter is a light emitter and wherein the detector is arranged to detect light transmitted through and around the at least one object, or through and around the at least one object within the dose of the filler material, to determine an integrity of the at least one object or to determine a presence or absence of the at least one object within the dose of the filler material.

Example Embodiment 3: The apparatus of any preceding example embodiment, or combinations thereof, wherein forming unit is arranged to form a pouched portion having a closed leading edge from the channel member, such that the pouched portion is arranged to receive and retain the dose of the filler material, having the at least one object within the dose, within the pouched portion.

Example Embodiment 4: The apparatus of any preceding example embodiment, or combinations thereof, wherein the forming unit is arranged to close a first portion of the channel member to form the closed leading edge of the pouched portion and a closed trailing edge of a previous pouched portion, and to close a second portion of the channel member to form a closed trailing edge of the pouched portion and a closed leading edge of a subsequent pouched portion.

Example Embodiment 5: The apparatus of any preceding example embodiment, or combinations thereof, wherein the forming unit is arranged to divide the channel member through the longitudinal axis, between the closed trailing edge and the closed leading edge of the respective pouched portions serially disposed along the longitudinal axis of the channel member, into a plurality of discrete pouched products such that each discrete pouched product includes therein the dose of the filler material, having the at least one object within the dose.

Example Embodiment 6: The apparatus of any preceding example embodiment, or combinations thereof, comprising a conveying unit arranged to receive the pouched products from the forming unit and to convey the pouched products to a packaging unit for packaging the pouched products.

Example Embodiment 7: The apparatus of any preceding example embodiment, or combinations thereof, comprising an inspection unit operably engaged with the conveying unit and arranged prior to the packaging unit to inspect each pouched product directed to the packaging unit, the inspection unit including an emitter arranged to oppose a detector such that the pouched products are conveyed therebetween.

Example Embodiment 8: The apparatus of any preceding example embodiment, or combinations thereof, wherein the emitter is a light emitter and wherein the detector is arranged to detect light transmitted through each conveyed pouched product to determine a presence or absence of the at least one object within the pouched product or to determine an integrity of the at least one object within the pouched product.

Example Embodiment 9: The apparatus of any preceding example embodiment, or combinations thereof, wherein the conveying unit is arranged to divert any pouched product, determined by the inspection unit to demonstrate the absence of the at least one object within the pouched product or to demonstrate a lack of integrity of the at least one object within the pouched product, away from the packaging unit.

Example Embodiment 10: The apparatus of any preceding example embodiment, or combinations thereof, wherein the dosage unit comprises a body member defining a filler channel extending therethough between a filler inlet and an outlet, and an object channel extending from an object inlet into communication with the filler channel between the filler inlet and the outlet, the object channel being arranged to receive the at least one object through the object inlet from the object metering unit in communication therewith, and to direct the at least one object into the filler channel, and the filler channel being arranged to receive the filler material through the filler inlet, to receive the at least one object from the object channel into the dose of the filler material, and to direct the dose of the filler material including the at least one object to the outlet for introduction of the dose into the pouched portion of the channel member.

Example Embodiment 11: The apparatus of any preceding example embodiment, or combinations thereof, wherein the body member defines a purge channel in communication with the object channel or the filler channel, before the outlet, the purge channel being arranged to receive a selectively actuated flow of a purge substance therein to clear the object channel or the filler channel of any objects or filler material remaining therein.

Example Embodiment 12: The apparatus of any preceding example embodiment, or combinations thereof, wherein the inspection unit is engaged with the body member such that the detector is opposed to the emitter across the object channel, or across the filler channel prior to or proximate the outlet.

Example Embodiment 13: The apparatus of any preceding example embodiment, or combinations thereof, wherein the at least one object includes capsules, pellets, microcapsules, beads, rods, flavoring agent members, or combinations thereof.

Example Embodiment 14: A method of manufacturing a pouched product, the method comprising feeding a continuous supply of a pouch material using a forming unit, the pouch material being configured as a continuous channel member defining a longitudinal axis; introducing at least one object into a dose of a filler material using a dosage unit operably engaged with the forming unit, and directing the dose of the filler material, having the at least one object within the dose, into the channel member; and inspecting the at least one object, or the at least one object within the dose of the filler material, using an inspection unit arranged prior to the dosage unit, operably engaged with the dosage unit, or arranged prior to the forming unit, the inspection unit including an emitter arranged to oppose a detector such that the at least one object, or the at least one object within the dose of the filler material, is directed therebetween.

Example Embodiment 15: The method of any preceding example embodiment, or combinations thereof, wherein the emitter is a light emitter and wherein the method comprises detecting light transmitted through and about the at least one object, or through and about the at least one object within the dose of the filler material, using the detector, to determine a presence or absence of the at least one object or to determine an integrity of the at least one object.

Example Embodiment 16: The method of any preceding example embodiment, or combinations thereof, comprising forming, using the forming unit, a pouched portion having a closed leading edge from the channel member, such that the pouched portion is arranged to receive and retain the dose of the filler material, having the at least one object within the dose, within the pouched portion.

Example Embodiment 17: The method of any preceding example embodiment, or combinations thereof, wherein forming the pouched portion comprises closing, using the forming unit, a first portion of the channel member to form the closed leading edge of the pouched portion and a closed trailing edge of a previous pouched portion, and closing, using the forming unit, a second portion of the channel member to form a closed trailing edge of the pouched portion and a closed leading edge of a subsequent pouched portion.

Example Embodiment 18: The method of any preceding example embodiment, or combinations thereof, comprising dividing, using the forming unit, the channel member through the longitudinal axis, between the closed trailing edge and the closed leading edge of the respective pouched portions serially disposed along the longitudinal axis of the channel member, into a plurality of discrete pouched products such that each discrete pouched product includes therein the dose of the filler material, having the at least one object within the dose.

Example Embodiment 19: The method of any preceding example embodiment, or combinations thereof, comprising receiving, using a conveying unit, the pouched products from the forming unit and conveying, using the conveying unit, the pouched products to a packaging unit for packaging the pouched products.

Example Embodiment 20: The method of any preceding example embodiment, or combinations thereof, comprising inspecting each pouched product directed to the packaging unit, using an inspection unit operably engaged with the conveying unit and arranged prior to the packaging unit, the inspection unit including an emitter arranged to oppose a detector such that the pouched products are conveyed therebetween.

Example Embodiment 21: The method of any preceding example embodiment, or combinations thereof, wherein the emitter is a light emitter and wherein inspecting each pouched product comprises detecting, using the detector, light transmitted through each conveyed pouched product, and determining a presence or absence of the at least one object within the pouched product or determining an integrity of the at least one object within the pouched product.

Example Embodiment 22: The method of any preceding example embodiment, or combinations thereof, comprising diverting, using the conveying unit, any pouched product, determined by the inspection unit to demonstrate the absence of the at least one object within the pouched product or to demonstrate a lack of integrity of the at least one object within the pouched product, away from the packaging unit.

Example Embodiment 23: The method of any preceding example embodiment, or combinations thereof, wherein the dosage unit comprises a body member defining a filler channel extending therethough between a filler inlet and an outlet, and an object channel extending from an object inlet into communication with the filler channel between the filler inlet and the outlet, and wherein introducing the at least one object comprises receive, by the object channel, the at least one object through the object inlet from the object metering unit in communication therewith and directing the at least one object into the filler channel, receiving, by the filler channel, the filler material through the filler inlet, receiving the at least one object from the object channel into the dose of the filler material, and directing the dose of the filler material including the at least one object to the outlet for introduction of the dose into the pouched portion of the channel member.

Example Embodiment 24: The method of any preceding example embodiment, or combinations thereof, wherein the body member defines a purge channel in communication with the object channel or the filler channel, before the outlet, and wherein the method comprises receive, by the purge channel, a selectively actuated flow of a purge substance therein to clear the object channel or the filler channel of any objects or filler material remaining therein.

Example Embodiment 25: The method of any preceding example embodiment, or combinations thereof, comprising engaging the inspection unit with the body member such that the detector is opposed to the emitter across the object channel, or across the filler channel prior to or proximate the outlet.

Example Embodiment 26: An apparatus for inspecting a pouched product, the apparatus comprising a forming unit arranged to form a pouched product from a pouch material, the pouched product having therein a dose of a filler material and at least one object within the dose; a conveying unit arranged to receive the pouched products from the forming unit and adapted to convey the pouched products to a packaging unit for packaging the pouched products; and an inspection unit operably engaged with the conveying unit and arranged prior to the packaging unit to inspect each pouched product directed to the packaging unit, the inspection unit including an emitter arranged to oppose a detector such that the pouched products are conveyed therebetween.

Example Embodiment 27: The apparatus of any preceding example embodiment, or combinations thereof, wherein the emitter is a light emitter and wherein the detector is arranged to detect light transmitted through each conveyed pouched product to determine a presence or absence of the at least one object within the pouched product or to determine an integrity of the at least one object within the pouched product.

Example Embodiment 28: The apparatus of any preceding example embodiment, or combinations thereof, wherein the conveying unit is arranged to divert any pouched product, determined by the inspection unit to demonstrate the absence of the at least one object within the pouched product or to demonstrate a lack of integrity of the at least one object within the pouched product, away from the packaging unit.

Example Embodiment 29: The apparatus of any preceding example embodiment, or combinations thereof, wherein the at least one object includes capsules, pellets, microcapsules, beads, rods, flavoring agent members, or combinations thereof.

Example Embodiment 30: A method of inspecting a pouched product, the method comprising forming a pouched product from a pouch material using a forming unit, the pouched product having therein a dose of a filler material and at least one object within the dose; receiving the pouched products from the forming unit with a conveying unit adapted to convey the pouched products toward a packaging unit for packaging the pouched products; and conveying the pouched products, with the conveying unit, through an inspection unit operably engaged with the conveying unit and arranged prior to the packaging unit, the inspection unit including an emitter arranged to oppose a detector such that the pouched products are conveyed therebetween, to inspect each pouched product directed toward the packaging unit.

Example Embodiment 31: The method of any preceding example embodiment, or combinations thereof, wherein the emitter is a light emitter and wherein the method comprises detecting light transmitted through each conveyed pouched product with the detector to determine a presence or absence of the at least one object within the pouched product or to determine an integrity of the at least one object within the pouched product. Example Embodiment 32: The method of any preceding example embodiment, or combinations thereof, comprising diverting, with the conveying unit, any pouched product, determined by the inspection unit to demonstrate the absence of the at least one object within the pouched product or to demonstrate a lack of integrity of the at least one object within the pouched product, away from the packaging unit.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

It will be appreciated that the summary herein is provided merely for purposes of summarizing some example aspects so as to provide a basic understanding of the disclosure. As such, it will be appreciated that the above described example aspects are merely examples and should not be construed to narrow the scope or spirit of the disclosure in any way. It will be appreciated that the scope of the disclosure encompasses many potential aspects, some of which will be further described below, in addition to those herein summarized. Further, other aspects and advantages of such aspects disclosed herein will become apparent from the following detailed description taken in conjunction with the accompanying drawings which illustrate, by way of example, the principles of the described aspects.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIGS. 1 and 2 schematically illustrate an apparatus for manufacturing a pouched product, according to one aspect of the present disclosure;

FIG. 3 schematically illustrates an apparatus for manufacturing a pouched product according to another aspect of the present disclosure;

FIGS. 4-7 are sectional perspective views of the apparatuses of FIGS. 1-3;

FIG. 8 schematically illustrates an as-formed pouched product conveyed by a conveying unit and inspected by an inspection unit, prior to packaging, according to one aspect of the present disclosure;

FIG. 9 schematically illustrates a conveying unit having an inspection unit operably engaged therewith, prior to packaging, according to one aspect of the present disclosure;

FIG. 10 schematically illustrates a method of manufacturing a pouched product, according to one aspect of the present disclosure;

FIG. 11 schematically illustrates a method of inspecting a pouched product, according to another aspect of the present disclosure; and FIGS. 12A and 12B schematically illustrate an apparatus for manufacturing a pouched product, according to one aspect of the present disclosure, demonstrating the apparatus mounted on a slidable mount for facilitating access to the apparatus for service, maintenance, or repair.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

Descriptions of various components of oral types of products and components thereof are set forth in U.S. Pat. App. Pub. No. 2004/0118422 to Lundin et al., which is incorporated herein by reference. See, also, for example, U.S. Pat. No. 4,607,479 to Linden; U.S. Pat. No. 4,631,899 to Nielsen; U.S. Pat. No. 5,346,734 to Wydick et al.; and U.S. Pat. No. 6,162,516 to Derr, and U.S. Pat. App. Pub. No. 2005/0061339 to Hansson et al.; each of which is incorporated herein by reference. See, also, the representative types of pouches, and pouch material or fleece, set forth in U.S. Pat. No. 5,167,244 to Kjerstad, which is incorporated herein by reference.

Representative pouched products may be manufactured using appropriately modified oral product manufacturing equipment. For example, a representative packaging machine, such as a Packaging Machine SB 53-2/T Forming-, Filling- and Sealing Machine from Merz Verpackungsmachinen GmbH may be suitably adapted for use with an object insertion device. G. D SpA, Hauni, and other manufacturers also supply tobacco or non-tobacco material pouching equipment. Oral pouches can be provided as individual pouches, or a plurality of pouches (e.g., 2, 4, 5, 10, 12, 15, 20, 25 or 30 pouches) can be connected or linked together (e.g., in an end-to-end manner) such that a single pouch or individual portion can be readily removed for use from a one-piece strand or matrix of pouches.

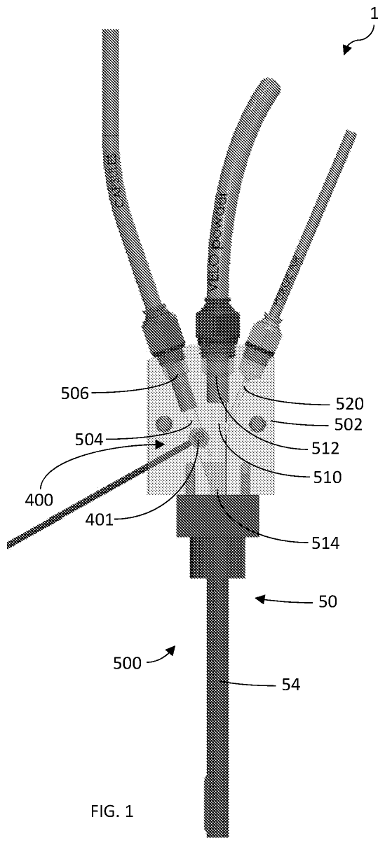

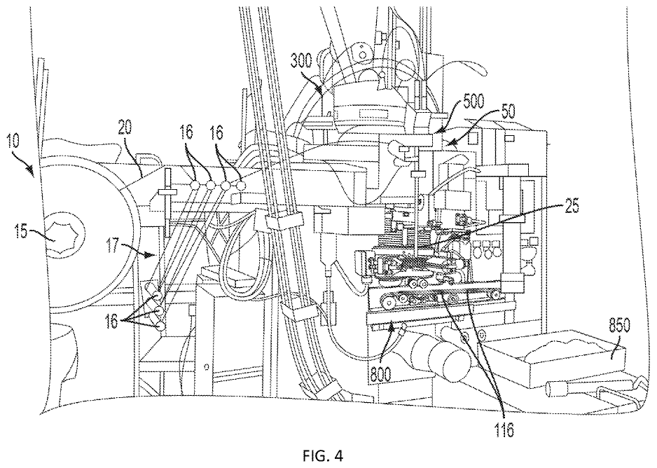

FIG. 1 illustrates an apparatus for manufacturing a pouched product, such as a tobacco-containing or non-tobacco containing pouched product, incorporating one or more objects (e.g., at least one object such as a rupturable capsule), according to one aspect of the present disclosure, the apparatus being indicated generally by the numeral 1. As shown in FIG. 4, such an apparatus 1 is arranged to removably receive a first bobbin 10 on an unwind spindle assembly 15, the first bobbin 10 having a continuous length of a material, such as a pouch material 20, wound thereon. When the first bobbin 10 is engaged with the apparatus 1, the pouch material 20 is routed from the first bobbin 10 to a forming unit 50 arranged to form a continuous supply of the pouch material 20 into a continuous channel member 25 defining a longitudinal axis.

As such, as the pouch material 20 is unwound from the first bobbin 10, the pouch material 20 is directed around an arrangement of roller members 16, otherwise referred to herein as a dancer assembly 17. The forming unit 50 is configured to cooperate with the first bobbin 10 and the dancer assembly 17 to take up slack in the pouch material 20 and to maintain a certain amount of longitudinal tension on the pouch material 20 as the pouch material 20 is unwound from the first bobbin 10 and fed to the forming unit 50, for example, by a drive system. One of ordinary skill in the art will appreciate that, between the first bobbin 10 and the forming unit 50, the pouch material 20 may be supported, routed, and/or guided by a suitably aligned series of any number of, for example, idler rollers, guideposts, air bars, turning bars, guides, tracks, tunnels, or the like, for directing the pouch material 20 along the desired path. Typical bobbins used by conventional automated pouch-making apparatuses often contain a continuous strip of pouch material 20 of which the length may vary. As such, the apparatus 10 described herein may be configured so as to handle bobbins of that type and size.

As shown in FIGS. 4-6, the forming unit 50 may include one or more roller members arranged to direct the pouch material 20 about a hollow shaft 54 such that the continuous supply of the pouch material 20 can be formed into the continuous channel (e.g., tubular) member 25, and the continuous supply of pouch material 20 configured as the continuous channel member 25 (defining a longitudinal axis) fed along the hollow shaft 54. The forming unit 50 may also include a sealing device 60 arranged to seal, fix, or otherwise engage the lateral edges of the pouch material 20 to form a longitudinally-extending seam, thereby forming the longitudinally-extending continuous channel member 25. A dosage unit 500 is operably engaged with the forming unit 50 and is arranged to introduce a dose of a filler material 130 (see FIG. 8, e.g., tobacco materials, non-tobacco materials, or powder products with nicotine added), having at least one object 134 (such as, for example, capsules (an outer shell 138 containing an inner payload 141, as shown in FIG. 8) and/or pellets, mini-capsules and/or mini-pellets, microcapsules, beads, rods, flavoring agent members, or combinations thereof) within the dose, into a pouched portion 116 (see, e.g., FIG. 8) of the channel member 25 through the hollow shaft 54. The dosage unit 500 may be directly or indirectly engaged with the hollow shaft 54. Upon receiving the dose, the pouched portion 116 has a closed leading edge 162 and, as such, the pouched portion 116 is arranged to retain therein the dose of the filler material 130, having the at least one object 134 within the dose. The apparatus 1 (see, e.g., FIGS. 1-3) is arranged to introduce objects 134 into the dosage unit 500, such that at least one object 134 is directed into the dose of the filler material 130 prior to the dose being directed into the pouched portion 116.

In some aspects, as shown in FIGS. 1-3, the dosage unit 500 comprises a body member 502 defining a filler channel 510 extending therethough between a filler inlet 512 and an outlet 514. The dosage unit 500 may include a filler hopper (not shown) for storing the filler material 130 and dispensing the filler material 130 in an amount sufficient to constitute a single dose of the filler material 130. A filler transfer unit (not shown, but e.g., a pressurized air source) may be engaged with the filler hopper 302 and arranged to direct the dose of filler material 130 to the dosage unit 500, for example, by a discharge of pressurized air (e.g., about 20 psi). The timing and duration of the discharge of pressurized air may be controlled by, for example, a mechanical valve (not shown). The dose of the filler material 130 may thus be introduced into the filler inlet 512 and pass through the body member 502, via the filler channel 510, which may be directly or indirectly engaged with the hollow shaft 54. The filler transfer unit is thus arranged to direct or facilitate movement of the dose of the filler material 130 through the filler inlet 512 and into the dosage unit 500/filler channel 510.

The body member 502 may further define an object channel 504 extending at least partially therein and connecting an object inlet 506 to the filler channel 510 between the filler inlet 512 and the outlet 514. In this regard, the one or more objects 134 may be received from the object metering unit 300 through the object inlet 506 and transported to the filler channel 510 via the object channel 504. As such, in some instances, the object channel 504 is arranged to receive the one or more objects 134 via the object inlet 506 and provide a passageway via the object channel 504 for transporting the one or more objects 134 to the filler channel 510. The filler channel 510 is arranged to receive the dose of the filler material 130 via the filler inlet 512, and the one or more objects 134 via the object channel 504. The filler channel 510 may be further configured to transport the dose of the filler material 130 having the one or more objects 134 therein to the outlet 514 for introduction into the pouched portion 116 of the continuous channel member 25 via the hollow shaft 54.

According to one aspect, as shown in FIGS. 1-3, the filler channel 510 may be linearly configured as defined by the body member 502 from the filler inlet 512 to the outlet 514, with the outlet 514 in communication with the hollow shaft 54 of the forming unit 50. The object channel 504 may be similarly linearly configured, extending from the object inlet 506 to merge into and converge with the filler channel 510, subsequent to the filler inlet 512 and prior to or in coincidence with the outlet 514 of the filler channel 510. However, the configurations of the filler channel 510 and the object channel 504 can vary, as necessary or desired, such that the delivery of the one or more objects 134 into the dose of the filler material 130 is accomplished without damage to the one or more objects 134. In one aspect, an object transfer unit (not shown) can be arranged to facilitate directing the one or more objects 134 through the object inlet 506 and along the object channel 504 into the dose of filler material 130 directed along the filler channel 510.

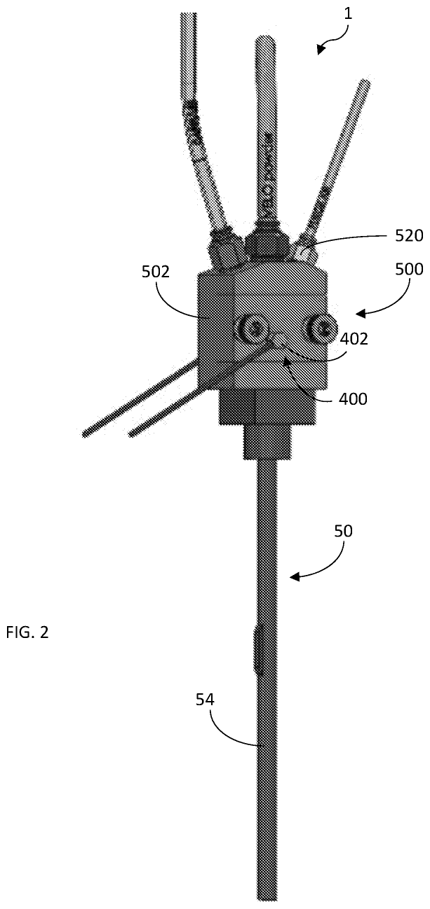

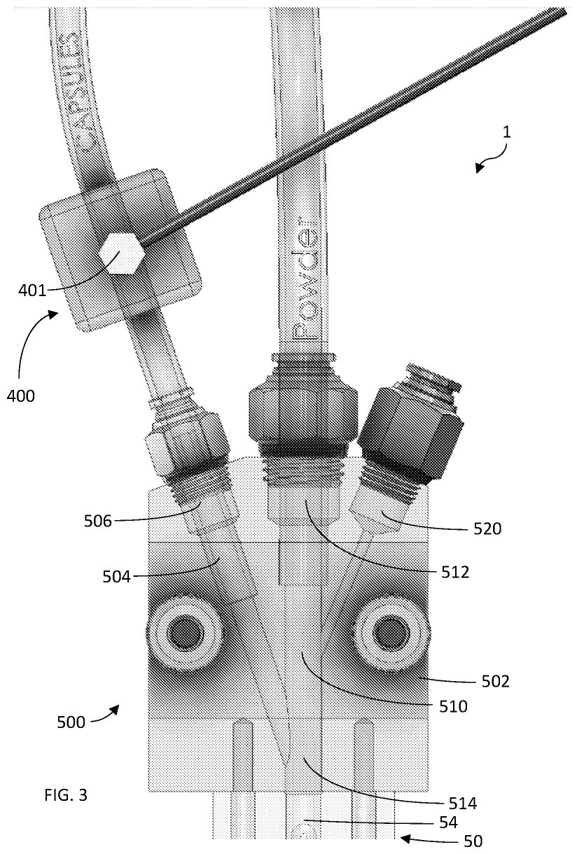

In some aspects, as shown in FIGS. 1-3, an inspection unit 400 is arranged prior to the dosage unit 500, is operably engaged with the dosage unit 500, or arranged prior to the forming unit 50. For example, the inspection unit 400 can be operably engaged with a conduit directing the at least one object 134 to the dosage unit 500 (see, e.g., FIG. 3), can be operably engaged with the dosage unit 500 itself (e.g., with the object channel 504 between the object channel inlet 506 and the filler channel 510-see, e.g., FIGS. 1 and 2), or otherwise arranged prior to the forming unit 50, to inspect the at least one object and/or the dose of the filler material 130 having the at least one object 134 within the dose, before the dose is directed through the hollow shaft 54 and into the pouched portion 116 of the continuous channel member 25. The inspection unit 400 can include, for example, an emitter 401 arranged to oppose a detector 402 such that the at least one object, or the dose of the filler material 130 having the at least one object 134 within the dose, is directed therebetween. In one example, the emitter 401 can comprise a relatively bright light (e.g., from an LED) backlighting the at least one object 134, the at least one object 134 within the dose of the filler material 130, and/or the pouched product 116 having the dose of the filler material 130 and the at least one object 134 therein. The detector may be, for example, a Cognex inspection camera arranged to oppose the emitter (light). With this light-based inspection system, the pouch material and filler material are at least partially translucent, wherein a difference in light transmissivity between the at least one object 134 and the dose of the filler material 130 and/or the pouch material, as detected by the detector, allows the at least one object 134 to be inspected and evaluated. In some instances, the emitter 401 is engaged with the body member 502 so as to extend into the filler channel 510 at or after the engagement of the object channel 504 with the filler channel 510 and before the outlet 514. Similarly, the detector 402 is engaged with the body member 502 so as to extend into the filler channel 510 at or after the engagement of the object channel 504 with the filler channel 510 and before the outlet 514, opposite the filler channel 510 from the emitter 401. In other instances, the emitter 401/detector 402 are opposed to each other and operably engaged with a conduit directing the at least one object 134 to the dosage unit 500, to inspect only the at least one object 134 as shown, for example, in FIG. 3.

The inspection by the inspection unit 400 can thus occur for just the at least one object 134 (e.g., prior to the combination of the at least one object 134 with the dose of the filler material), upon combination of the at least one object 134 with the dose of the filler material 130 (e.g., about the intersection between the object channel 504 and the filler channel 510), or immediately thereafter prior to the dose of the filler material 130 having the at least one object 134 therein being directed into the hollow shaft 54 of the forming unit 50. Moreover, the inspection can occur as the at least one object 134, or the dose of the filler material 130 having the at least one object 134 therein, is directed, unimpeded, between the emitter 401/detector 402.

In some instances, the object channel 504 and/or the filler channel 510 can have a gate arrangement (not shown) operably engaged therewith for retaining the at least one object 134, or the dose of the filler material 130 having the at least one object 134 therein, for inspection by the inspection unit 400, prior to releasing the at least one object 134 into the dose of the filler material 130, or releasing the dose into the hollow shaft 54. In such instances of the object channel 504 and/or the filler channel 510 having a gate arrangement, if the inspection unit 400 determines that the at least one object 134, by itself or in the dose of the filler material 130, is irregular, the gate arrangement may be further configured to divert that at least one object 134 away from the dose of the filler material 130, or to divert that dose of the filler material 130 having the irregular object therein, away from the hollow channel 54 of the forming unit 50 so as to avoid forming a pouched portion 116 having an irregular object 134 therein. In some aspects, a dose transfer unit (not shown, but e.g., a pressurized air source) can be operably engaged with the dosage unit 500, and arranged to direct the dose of the filler material 130 having the (normal) at least one object 134 from the dosage unit 500 into the hollow shaft 54 of the forming unit 50, and subsequently into the pouched portion 116 of the continuous channel member 25.

In some aspects, the emitter 401 is configured to emit a signal across the object channel 504 or the filler channel 510, wherein the signal interacts with the at least one object 134 or the dose of the filler material 130 having the at least one object 134 therein, before being detected by the detector 402. In this manner, the emitter 401/detector 402 can be configured, for example, to detect the presence/absence of the at least one object 134, to detect the presence/absence of the one or objects 134 in the dose of the filler material 130, determine the integrity (e.g., whether the one or more objects 134 is/are intact or have been damaged upon being combined with the dose of the filler material 130) of the one or more objects 134 alone or in the dose of the filler material 130, and/or determine whether the object channel 504 or the filler channel 510 is clear or blocked. Accordingly, in some aspects, multiple inspection units 400 can be engaged with the body member 502 and/or arranged prior to the body member 502, as necessary or desired, to monitor the condition of the object channel 504 and/or the filler channel 510 at various locations on the body member 502.

In some aspects, the emitter 401 is a light emitter and the detector 402 is arranged to detect light transmitted about/through the at least one object 134 or through the dose of the filler material 130, having the at least one object 134 within the dose (e.g., backlighting the at least one object 134, or the dose of the filler material 130 having the at least one object 134 therein), to determine, for example, a presence or absence of the at least one object 134 or to determine an integrity of the at least one object 134. The emitted light may be of any suitable wavelength (visible, infrared, etc.), as necessary or desired, so as to be at least partially attenuated by the at least one object 134, in contrast with the light passing around the at least one object 134, or the light being attenuated by the filler material 130, upon interaction of the emitted light therewith. The detector 402 may be in operable communication with, for example, a vision system configured to process the detected light to determine a contrast between the at least one object 134 and the filler material 134 and/or to determine whether the backlit image of the one or more objects 134 corresponds with the expected object shape or configuration (e.g., whether the detected capsule is shaped as-expected as a model capsule or whether an irregular shape indicates that the capsule has ruptured). One skilled in the art will appreciate, however, that the inspection unit 400 may be configured in different manners, besides as a light emitter/detector, as long as sufficient and appropriate to provide for contrast/discernment of the at least one object 134 or between the at least one object and the filler material, and to allow the configuration/integrity of the at least one object to be assessed and verified.

In one aspect, the body member 502 may define a purge channel 520 in communication with the object channel 504 between the object inlet 506 and the filler channel 510 and/or in communication with the filler channel 510 between the filler inlet 512 and the object channel 504 (with the latter being illustrated in FIGS. 1-3). The purge channel 520 may be fluidly connect to a blower assembly or other source (not shown, but e.g., a pressurized air source) of a purge substance such as pressurized air for discharging air into the purge channel 520 so as to assist in moving any residual objects and/or filler material from the object channel 504 and/or the filler channel 510. In some instances, the blower/pressurized air assembly may provide, for instance, approximately 15-40 psi of force for a flow duration, for example, of approximately 15 seconds to 5 minutes, to assist with removing residual objects and/or filler material from the object channel 504 and/or the filler channel 510. In some aspects, the source of the purge substance may include, for example, a cleaning substance in addition to or instead of pressurized air. In other aspects, a clearing unit (not shown, but e.g., a mechanical rod or pipe cleaner) can be operably engaged with the dosage unit 500, with the clearing unit being arranged to be selectively actuated (e.g., the mechanical rod or pipe cleaner introduced into and moved along the object channel 504 or along the filler channel 510) so as to clear the dosage unit 500 of any residual objects or filler material remaining therein.

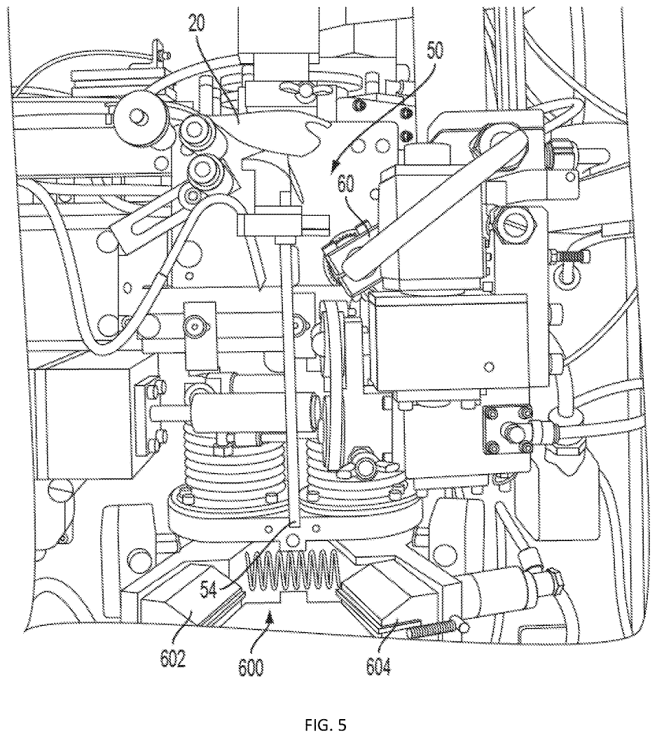

As shown, for example, in FIGS. 5 and 7, a leading edge or end 162 of the continuous channel member 25 may be closed/sealed such that a charge or dose of filler material 130, and the object(s) 134 introduced into the dose of the filler material 130, in the dosage unit 500 are introduced into and contained within the continuous channel member 25 proximate to the leading end 162. The leading end 162 may be closed/sealed via a closing and dividing component 600 of the forming unit 50 arranged to close/seal a first portion 26 (see, e.g., FIG. 8) of the continuous channel member 25 to form the closed leading end 162 of a pouched portion 116. The closing and dividing component 600 may also be arranged to form a closed trailing edge or end 165 of a previous pouched portion 116. In this regard, the closing and dividing component 600 may also be arranged to close a second portion 27 of the continuous channel member 25 to form the closed trailing end 165 of the pouched portion 116. The closing and dividing component 600 may also be arranged to form a closed leading edge 162 of a subsequent pouched portion 116. That is, the closing and dividing component 600 may be arranged to close the trailing end 165 of one pouched portion 116 while simultaneously closing the leading end 162 of a subsequent pouched portion 116 formed from the continuous channel member 25. In this regard, the closing and dividing component 600 may close the ends 162, 165 by heat-sealing, a suitable adhesive, or other suitable sealing mechanism for the pouch material.

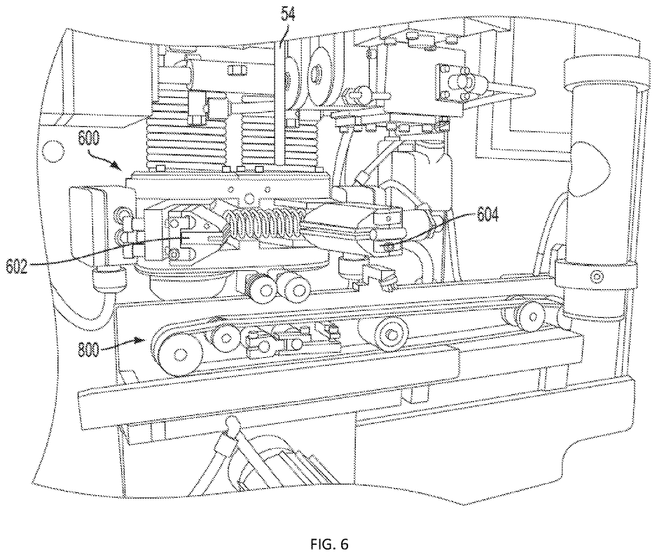

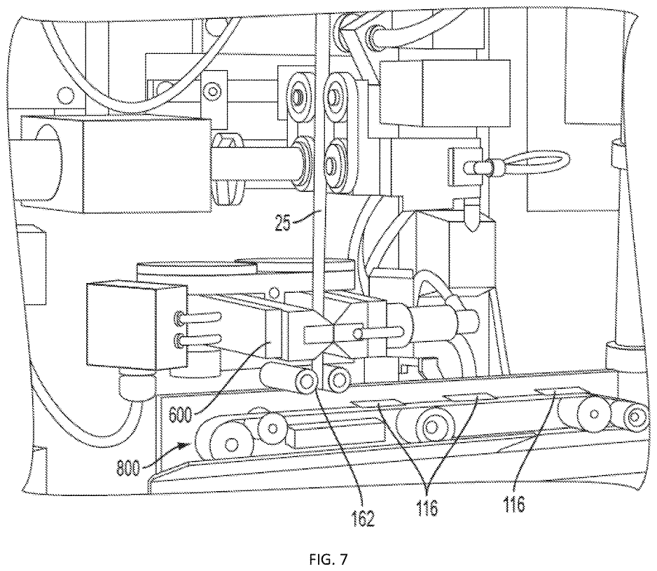

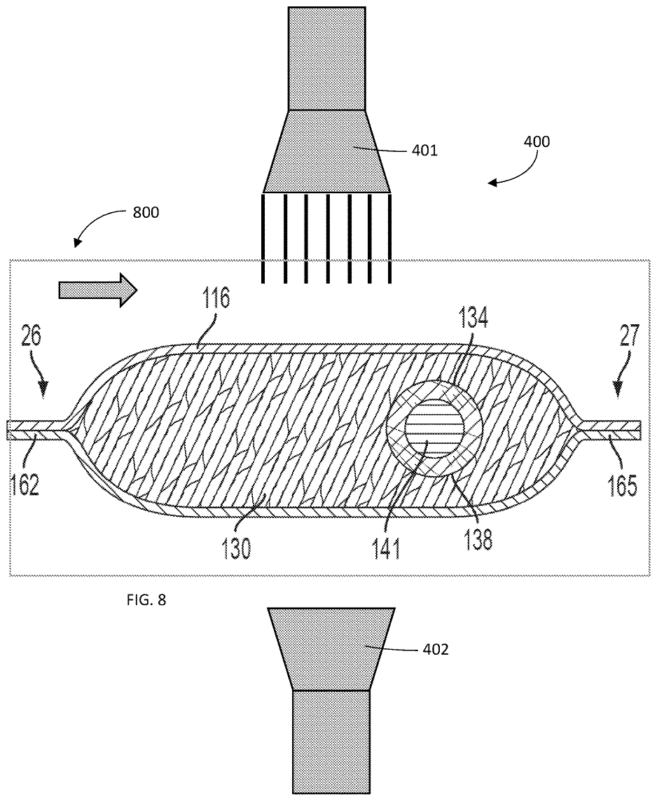

Furthermore, the closing and dividing component 600 may be arranged to divide the continuous channel member 25, between the closed trailing end 165 and the closed leading end 162 of serially-disposed pouched portions 116, along the longitudinal axis of the continuous channel member 25, and into a plurality of discrete pouched portions 116 such that each discrete pouched portion 116 includes a dose of the filler material 130 from the dosage unit 500 having at least one of the objects 134 from the object metering unit 300 therein, as shown in FIG. 8 and as described further herein. In this regard, the closing and dividing component 600 may include a blade, heated wire, or other cutting arrangement for severing the continuous channel member 25 into discrete pouched portions 116. For example, the closing and dividing component 600 may include first and second arm members 602, 604 configured to interact to close and divide the continuous channel member 25, as generally shown in FIGS. 5 and 6.

In operation, a charge or dose of filler material 130 (i.e., an amount suitable for inserting in an individual pouched portion 116) is supplied to the pouched portion 116 by the dosage unit 500 after the leading end 162 has been closed, but prior to the closing of the trailing end 165. Similarly, one or more objects 134 is supplied to the dose of filler material 130 by the object metering unit 300 and the combined dose then directed to the forming unit 50 after the leading end 162 of the pouched portion 116 has been closed, but prior to the closing of the trailing end 165 of the pouched portion 116. After receiving the dose of filler material 130 having the one or more objects 134 therein, the discrete individual pouched portion 116 is formed by closing the trailing end 165 and severing the closed pouched portion 116 from the continuous channel member 25 such that an individual pouched product, incorporating at least one object 134 within the dose of the filler material 130, is formed.

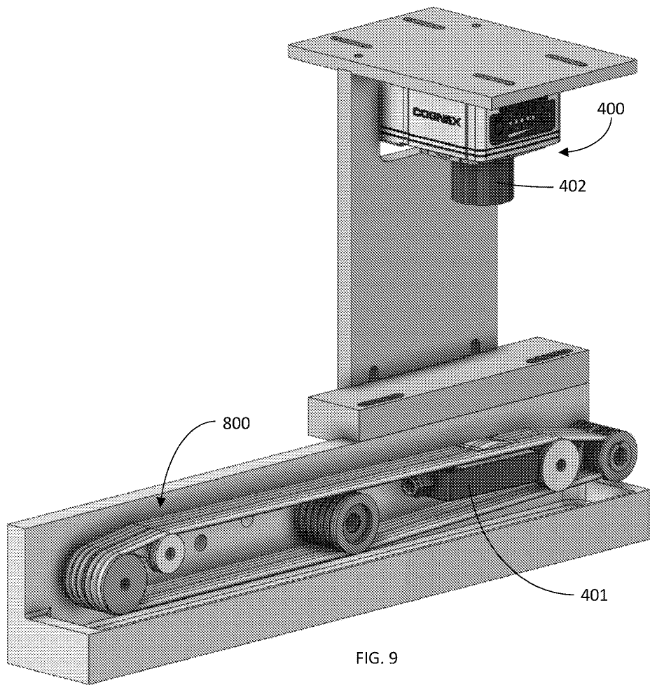

In some instances, the apparatus 1 may be configured and arranged to produce approximately 300 pouched portions 116 per minute. A conveying unit 800 (see, e.g., FIGS. 8 and 9) may be provided proximate to the closing and dividing component 600 such that, after being severed from the continuous channel member 25, each individual pouched portion 116 (at this point, an as-formed pouched product) is received by the conveying unit 800 and transported away from the apparatus 1 to, for example, a storage bin or container or a packaging unit. In some instances, each individual pouched portion 116 may be transported by the conveying unit 800 to operably engage and be directed through an inspection unit 400, as disclosed herein, prior to the storage bin/container 850 (see e.g., FIG. 4) or the packaging unit. That is, in some aspects as shown in FIGS. 8 and 9, the inspection unit 400 includes an emitter 401 configured to emit a signal across the conveyor 800, wherein the signal interacts with the individual pouched portion 116 having the dose of the filler material 130 and the at least one object 134 therein, before being detected by the detector 402. In this manner, the emitter 401/detector 402 can be configured, for example, to detect the presence/absence of the one or objects 134 within the dose of the filler material 130 within the pouched portion 116 and/or to determine the integrity (e.g., whether the one or more objects 134 is/are intact or have been damaged upon being combined with the dose of the filler material 130 in the pouched portion 116) of the one or more objects 134 within the dose of the filler material 130 within the pouched portion 116.

In some aspects, the emitter 401 is a light emitter and the detector 402 is arranged to detect light transmitted through the pouched portion/pouched product 116, having therein the dose of the filler material 130 and the at least one object 134 therein (e.g., backlighting the pouched portion/pouched product 116 having the dose of the filler material 130 and the at least one object 134 therein), to determine, for example, a presence or absence of the at least one object 134 or to determine an integrity of the at least one object 134 within the pouched portion/pouched product 116. The emitted light may be of any suitable wavelength (visible, infrared, etc.), as necessary or desired, so as to be at least partially attenuated by the at least one object 134, in contrast with the attenuation by the filler material 130 and the pouch material, upon interaction of the emitted light therewith. The detector 402 may be in operable communication with, for example, a vision system configured to process the detected light to determine a contrast between the at least one object 134 and the filler material 134 and pouch material and/or to determine whether the backlit image of the one or more objects 134 corresponds with the expected object shape or configuration (e.g., whether the detected capsule is shaped as-expected as a model capsule or whether an irregular shape indicates that the capsule has ruptured). One skilled in the art will appreciate, however, that the inspection unit 400 may be configured in different manners, besides as a light emitter/detector, as long as sufficient and appropriate to provide for contrast/discernment between the at least one object and the filler material and pouch material, and to allow the configuration/integrity of the at least one object to be assessed and verified. For example, the emitter/detector may be configured to measure microwave density of the one or more objects 134, or in other instances, the emitter/detector may be capable of determining whether an object is leaking its payload by being configured to sense an ultraviolet (UV) tracer originally included in the payload of the object. Other emitter/detector systems as known by those of ordinary skill in the art may be employed for determining, for example, the absence and/or presence of objects, object defects, and other detectable object properties within the pouched portion/pouched product 116.

In some aspects, the conveying unit 800 is arranged to divert any pouched portion/pouched product 116, determined by the inspection unit 400 to demonstrate the absence of the at least one object 134 within the pouched portion/pouched product 116 or to demonstrate a lack of integrity of the at least one object 134 within the pouched portion/pouched product 116, away from the packaging unit or storage bin/container (e.g., by way of a diverter device 875 as shown in FIGS. 12A and 12B). In such aspects, pouched portions/pouched products 116 determined to have object(s) lacking integrity can be diverted by the diverter device 875 of the conveying unit 800 to be rejected or discarded. In addition, pouched portions/pouched products determined to lack the object(s) therein can be diverted by the diverter device 875 of the conveyor 800 and packaged as pouched products without any objects therein.

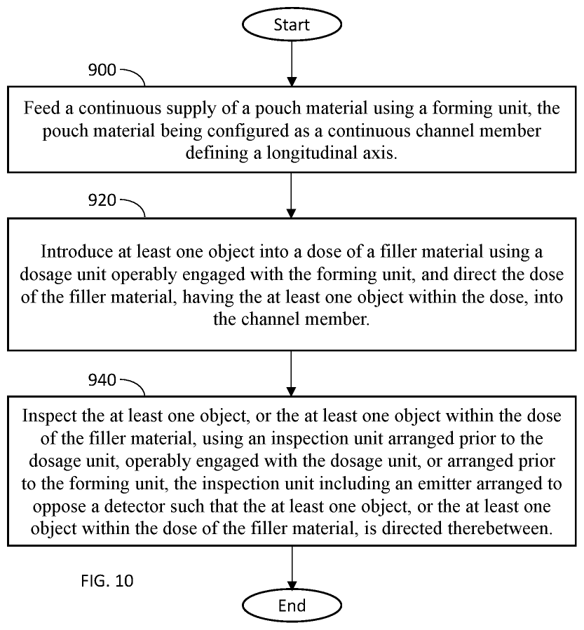

Still another aspect comprises a method of manufacturing a pouched product, as disclosed herein and schematically illustrated in FIG. 10. More particularly, such a method comprises feeding a continuous supply of a pouch material using a forming unit, the pouch material being configured as a continuous channel member defining a longitudinal axis (Block 900). At least one object is introduced into a dose of a filler material using a dosage unit operably engaged with the forming unit, and the dose of the filler material, having the at least one object within the dose, is directed into the channel member (Block 920). The at least one object, or the at least one object within the dose of the filler material, is inspected using an inspection unit arranged prior to the dosage unit, operably engaged with the dosage unit, or arranged prior to the forming unit, wherein the inspection unit includes an emitter arranged to oppose a detector such that the at least one object, or the at least one object within the dose of the filler material, is directed therebetween (Block 940).

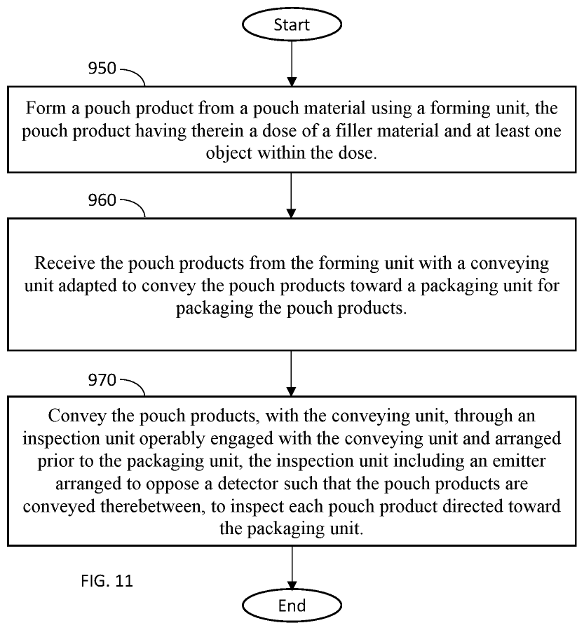

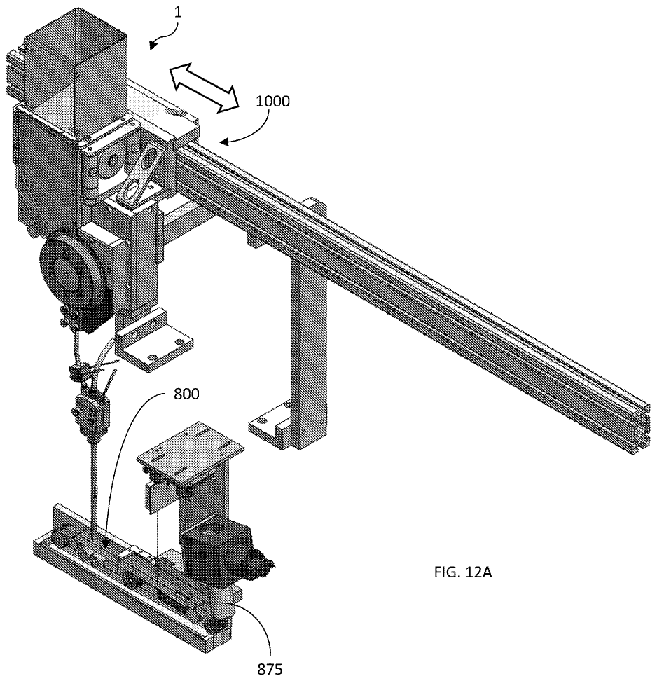

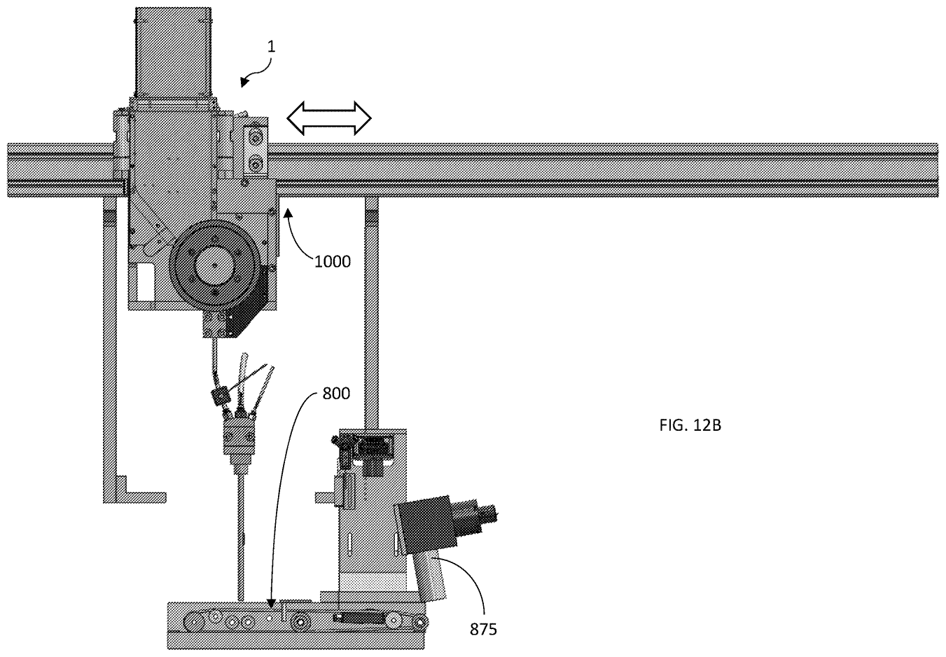

Yet another aspect comprises a method of inspecting a pouched product, as disclosed herein and schematically illustrated in FIG. 11. More particularly, such a method comprises forming a pouched product from a pouch material using a forming unit, the pouched product having therein a dose of a filler material and at least one object within the dose (Block 950). The pouched products are received from the forming unit with a conveying unit adapted to convey the pouched products toward a packaging unit for packaging the pouched products (Block 960). The pouched products are conveyed, with the conveying unit, through an inspection unit operably engaged with the conveying unit and arranged prior to the packaging unit, wherein the inspection unit includes an emitter arranged to oppose a detector such that the pouched products are conveyed therebetween, to inspect each pouched product directed toward the packaging unit (Block 970).

The present disclosure can be utilized with a variety of filler materials without departing from the invention. In certain embodiments, the filler material comprises a filler such as microcrystalline cellulose (generally in an amount of at least 20% by weight), at least one active ingredient such as one or more of botanical materials, stimulants, amino acids, vitamins, antioxidants, cannabinoids, pharmaceutical agents, nicotine (in base, salt or complex form), and combinations thereof, and optionally further ingredients such as cellulose derivatives (e.g., hydroxypropylcellulose), organic acids, salts, sweeteners, flavorants, and tobacco. See, for example, the types of oral compositions set forth in US2021/0068447 to Keller et al.;

US2021/0169889 to Keller et al.; US2021/0177043 to Gerardi et al.; US2021/0206554 to Holton Jr. et al; and US2022/0071984 to Poole et al, each of which is incorporated by reference in its entirety.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. For example, as shown in FIGS. 12A and 12B, the apparatus 1 may be mounted on a slide device 1000. The movable/slidable mounting of the apparatus 1 on the slide device 1000, for example, allows the apparatus 1 to be movable to facilitate access to the apparatus 1 and/or surrounding components (such as the conveying unit 800) for service, maintenance, or repair purposes.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

That which is claimed:

1. An apparatus for manufacturing a pouched product, the apparatus comprising:
a forming unit arranged to form a continuous supply of a pouch material into a continuous channel member defining a longitudinal axis;
a dosage unit operably engaged with the forming unit and arranged to receive at least one object and to introduce the at least one object into a dose of a filler material, the dosage unit being further arranged to direct the dose of the filler material, having the at least one object within the dose, into the channel member; and
an inspection unit arranged prior to the dosage unit, operably engaged with the dosage unit, or arranged prior to the forming unit, the inspection unit further being arranged to inspect the at least one object prior to insertion thereof into the dose of the filler material, or to inspect the dose of the filler material having the at least one object within the dose, the inspection unit including an emitter arranged to oppose a detector such that the at least one object, or the dose of the filler material having the at least one object within the dose, is directed therebetween.

2. The apparatus of claim 1, wherein the emitter is a light emitter and wherein the detector is arranged to detect light transmitted through and around the at least one object, or through and around the at least one object within the dose of the filler material, to determine an integrity of the at least one object or to determine a presence or absence of the at least one object within the dose of the filler material.

3. The apparatus of claim 1, wherein forming unit is arranged to form a pouched portion having a closed leading edge from the channel member, such that the pouched portion is arranged to receive and retain the dose of the filler material, having the at least one object within the dose, within the pouched portion.

4. The apparatus of claim 3, wherein the forming unit is arranged to close a first portion of the channel member to form the closed leading edge of the pouched portion and a closed trailing edge of a previous pouched portion, and to close a second portion of the channel member to form a closed trailing edge of the pouched portion and a closed leading edge of a subsequent pouched portion.

5. The apparatus of claim 4, wherein the forming unit is arranged to divide the channel member through the longitudinal axis, between the closed trailing edge and the closed leading edge of the respective pouched portions serially disposed along the longitudinal axis of the channel member, into a plurality of discrete pouched products such that each discrete pouched product includes therein the dose of the filler material, having the at least one object within the dose.

6. The apparatus of claim 5, comprising a conveying unit arranged to receive the pouched products from the forming unit and to convey the pouched products to a packaging unit for packaging the pouched products.

7. The apparatus of claim 6, comprising an inspection unit operably engaged with the conveying unit and arranged prior to the packaging unit to inspect each pouched product directed to the packaging unit, the inspection unit including an emitter arranged to oppose a detector such that the pouched products are conveyed therebetween.

8. The apparatus of claim 7, wherein the emitter is a light emitter and wherein the detector is arranged to detect light transmitted through each conveyed pouched product to determine a presence or absence of the at least one object within the pouched product or to determine an integrity of the at least one object within the pouched product.

9. The apparatus of claim 8, wherein the conveying unit is arranged to divert any pouched product, determined by the inspection unit to demonstrate the absence of the at least one object within the pouched product or to demonstrate a lack of integrity of the at least one object within the pouched product, away from the packaging unit.

10. The apparatus of claim 1, wherein the dosage unit comprises a body member defining a filler channel extending therethough between a filler inlet and an outlet, and an object channel extending from an object inlet into communication with the filler channel between the filler inlet and the outlet, the object channel being arranged to receive the at least one object through the object inlet from the object metering unit in communication therewith, and to direct the at least one object into the filler channel, and the filler channel being arranged to receive the filler material through the filler inlet, to receive the at least one object from the object channel into the dose of the filler material, and to direct the dose of the filler material including the at least one object to the outlet for introduction of the dose into the pouched portion of the channel member.

11. The apparatus of claim 10, wherein the body member defines a purge channel in communication with the object channel or the filler channel, before the outlet, the purge channel being arranged to receive a selectively actuated flow of a purge substance therein to clear the object channel or the filler channel of any objects or filler material remaining therein.

12. The apparatus of claim 10, wherein the inspection unit is engaged with the body member such that the detector is opposed to the emitter across the object channel, or across the filler channel prior to or proximate the outlet.

13. The apparatus of claim 1, wherein the at least one object includes capsules, pellets, microcapsules, beads, rods, flavoring agent members, or combinations thereof.

14. A method of manufacturing a pouched product, the method comprising:
feeding a continuous supply of a pouch material using a forming unit, the pouch material being configured as a continuous channel member defining a longitudinal axis;
introducing at least one object into a dose of a filler material using a dosage unit operably engaged with the forming unit, and directing the dose of the filler material, having the at least one object within the dose, into the channel member; and
inspecting the at least one object, or the at least one object within the dose of the filler material, using an inspection unit arranged prior to the dosage unit, operably engaged with the dosage unit, or arranged prior to the forming unit, the inspection unit including an emitter arranged to oppose a detector such that the at least one object, or the at least one object within the dose of the filler material, is directed therebetween.

15. The method of claim 14, wherein the emitter is a light emitter and wherein the method comprises detecting light transmitted through and about the at least one object, or through and about the at least one object within the dose of the filler material, using the detector, to determine a presence or absence of the at least one object or to determine an integrity of the at least one object.

16. The method of claim 14, comprising forming, using the forming unit, a pouched portion having a closed leading edge from the channel member, such that the pouched portion is arranged to receive and retain the dose of the filler material, having the at least one object within the dose, within the pouched portion.

17. The method of claim 16, wherein forming the pouched portion comprises closing, using the forming unit, a first portion of the channel member to form the closed leading edge of the pouched portion and a closed trailing edge of a previous pouched portion, and closing, using the forming unit, a second portion of the channel member to form a closed trailing edge of the pouched portion and a closed leading edge of a subsequent pouched portion.

18. The method of claim 17, comprising dividing, using the forming unit, the channel member through the longitudinal axis, between the closed trailing edge and the closed leading edge of the respective pouched portions serially disposed along the longitudinal axis of the channel member, into a plurality of discrete pouched products such that each discrete pouched product includes therein the dose of the filler material, having the at least one object within the dose.

19. The method of claim 18, comprising receiving, using a conveying unit, the pouched products from the forming unit and conveying, using the conveying unit, the pouched products to a packaging unit for packaging the pouched products.

20. The method of claim 19, comprising inspecting each pouched product directed to the packaging unit, using an inspection unit operably engaged with the conveying unit and arranged prior to the packaging unit, the inspection unit including an emitter arranged to oppose a detector such that the pouched products are conveyed therebetween.

21. The method of claim 20, wherein the emitter is a light emitter and wherein inspecting each pouched product comprises detecting, using the detector, light transmitted through each conveyed pouched product, and determining a presence or absence of the at least one object within the pouched product or determining an integrity of the at least one object within the pouched product.

22. The method of claim 21, comprising diverting, using the conveying unit, any pouched product, determined by the inspection unit to demonstrate the absence of the at least one object within the pouched product or to demonstrate a lack of integrity of the at least one object within the pouched product, away from the packaging unit.

23. The method of claim 14, wherein the dosage unit comprises a body member defining a filler channel extending therethough between a filler inlet and an outlet, and an object channel extending from an object inlet into communication with the filler channel between the filler inlet and the outlet, and wherein introducing the at least one object comprises receive, by the object channel, the at least one object through the object inlet from the object metering unit in communication therewith and directing the at least one object into the filler channel, receiving, by the filler channel, the filler material through the filler inlet, receiving the at least one object from the object channel into the dose of the filler material, and directing the dose of the filler material including the at least one object to the outlet for introduction of the dose into the pouched portion of the channel member.

24. The method of claim 23, wherein the body member defines a purge channel in communication with the object channel or the filler channel, before the outlet, and wherein the method comprises receive, by the purge channel, a selectively actuated flow of a purge substance therein to clear the object channel or the filler channel of any objects or filler material remaining therein.

25. The method of claim 23, comprising engaging the inspection unit with the body member such that the detector is opposed to the emitter across the object channel, or across the filler channel prior to or proximate the outlet.

26. An apparatus for inspecting a pouched product, the apparatus comprising:
a forming unit arranged to form a pouched product from a pouch material, the pouched product having therein a dose of a filler material and at least one object within the dose;
a conveying unit arranged to receive the pouched products from the forming unit and adapted to convey the pouched products to a packaging unit for packaging the pouched products; and
an inspection unit operably engaged with the conveying unit and arranged prior to the packaging unit to inspect each pouched product directed to the packaging unit, the inspection unit including an emitter arranged to oppose a detector such that the pouched products are conveyed therebetween.

27. The apparatus of claim 26, wherein the emitter is a light emitter and wherein the detector is arranged to detect light transmitted through each conveyed pouched product to determine a presence or absence of the at least one object within the pouched product or to determine an integrity of the at least one object within the pouched product.

28. The apparatus of claim 27, wherein the conveying unit is arranged to divert any pouched product, determined by the inspection unit to demonstrate the absence of the at least one object within the pouched product or to demonstrate a lack of integrity of the at least one object within the pouched product, away from the packaging unit.

29. The apparatus of claim 26, wherein the at least one object includes capsules, pellets, microcapsules, beads, rods, flavoring agent members, or combinations thereof.

30. A method of inspecting a pouched product, the method comprising:
forming a pouched product from a pouch material using a forming unit, the pouched product having therein a dose of a filler material and at least one object within the dose;
receiving the pouched products from the forming unit with a conveying unit adapted to convey the pouched products toward a packaging unit for packaging the pouched products; and
conveying the pouched products, with the conveying unit, through an inspection unit operably engaged with the conveying unit and arranged prior to the packaging unit, the inspection unit including an emitter arranged to oppose a detector such that the pouched products are conveyed therebetween, to inspect each pouched product directed toward the packaging unit.

31. The method of claim 30, wherein the emitter is a light emitter and wherein the method comprises detecting light transmitted through each conveyed pouched product with the detector to determine a presence or absence of the at least one object within the pouched product or to determine an integrity of the at least one object within the pouched product.

32. The method of claim 31, comprising diverting, with the conveying unit, any pouched product, determined by the inspection unit to demonstrate the absence of the at least one object within the pouched product or to demonstrate a lack of integrity of the at least one object within the pouched product, away from the packaging unit.
